(19) United States
(12) Patent Application Publication
(10) Pub. No.: US 2026/0299207 A1
(43) Pub. Date: Oct. 1, 2026

(54) WAVELENGTH FILTER AND WAVELENGTH TUNABLE LIGHT SOURCE

(71) Applicant: NEC Corporation, Tokyo (JP)

(72) Inventor: Ryo KURAHASHI, Tokyo (JP)

(73) Assignee: NEC Corporation, Tokyo (JP)

(21) Appl. No.: 19/564,814

(22) Filed: Mar. 12, 2026

(30) Foreign Application Priority Data
Mar. 25, 2025 (JP) 2025-050242

(51) Int. Cl. G02B 6/293

(52) U.S. Cl. CPC G02B 6/29338; G02B 6/29395

(57) ABSTRACT

A splitter splits input light into first and second split light. A first optical waveguide propagates the first split light from the splitter to a first optical coupling unit. A second optical waveguide propagates the second split light from the splitter to a second optical coupling unit. The first split light from the first optical coupling unit circulates a first ring-shaped optical waveguide. A second ring-shaped optical waveguide has an optical path length shorter than the first ring-shaped optical waveguide, and the second split light from the second optical coupling unit circulates the second ring-shaped optical waveguide. A third optical waveguide propagates light between a third optical coupling unit and a fourth optical coupling unit. A first optical path length between the splitter and the first optical coupling unit is shorter than a second optical path length between the splitter and the second optical coupling unit.

### INCORPORATION BY REFERENCE

This application is based upon and claims the benefit of priority from Japanese patent application No. 2025-050242, filed on Mar. 25, 2025, the disclosure of which is incorporated herein in its entirety by reference.

### TECHNICAL FIELD

The present disclosure relates to a wavelength filter and a wavelength tunable light source.

### BACKGROUND ART

An optical transceiver used in an optical communication network uses a wavelength tunable laser device as a light source of an optical signal. For example, an external resonator type wavelength tunable laser device has been known that is obtained by combining a Semiconductor Optical Amplifier (SOA) and a wavelength filter including a double ring type resonator including two optical waveguide type ring resonators.

In an external resonator to which silicon photonics technology is applied, an optical waveguide configuring a ring resonator may include silicon. Here, in general, since a silicon optical waveguide has a smaller waveguide sectional area than a silica-based optical waveguide, an optical loss caused by two-photon absorption that is a nonlinear optical phenomenon is likely to occur. As a result, there is an upper limit of an intensity of light that can pass through the optical waveguide. Since light having a specific wavelength remains in the waveguide and the light resonates and is reinforced in the ring resonator, a nonlinear optical effect is likely to occur.

Therefore, in an external resonator having a structure in which the two ring resonators are connected in series, even in a case where an output intensity of light from the SOA is increased to obtain a sufficient optical output, since the ring resonator at a preceding stage particularly limits optical power that can exist in its waveguide, there is a case where an output of laser light becomes insufficient. Therefore, for example, as in International Patent Publication No. WO 2007/029647 A1, a wavelength tunable laser device has been proposed that includes an external resonator having a structure in which two ring resonators are arranged in parallel, in order to lower an intensity of light in the ring resonator.

In the external resonator of the wavelength tunable laser device in International Patent Publication No. WO 2007/029647 A1, laser light from the SOA enters one input/output optical waveguide. Thereafter, the laser light is split into two optical waveguides, and enters each of the two ring resonators. The laser light that has circulated the one ring resonator circulates the other ring resonator, via the optical waveguide that connects drop ports of the two ring resonators. Thereafter, the pieces of the laser light emitted from the two ring resonators are coupled into the input/output optical waveguide, and the multiplexed laser light is emitted to the SOA. In this external resonator, round lengths of the pieces of the laser light of the two ring resonators are different from each other. As a result, an oscillation wavelength range and an oscillation wavelength of the wavelength tunable laser device are determined, by a so-called vernier effect.

In this configuration, normally, by changing a temperature of the optical waveguide configuring the ring resonator by a heater, it is possible to change an effective index of the optical waveguide with respect to the propagating laser light. As a result, the oscillation wavelength of the wavelength tunable laser device can be controlled to a desired value. Here, since it is necessary to individually control the temperatures of the two ring resonators, the heaters provided in the two ring resonators are arranged at a distance that can prevent an influence of heat, in such a way that heat generation caused by the heater provided in the one ring resonator does not affect the other ring resonator.

### SUMMARY

Even in a wavelength tunable laser device according to International Patent Publication No. WO 2007/029647 A1, optical losses in optical waveguide propagation are different, between two ring resonators having different round lengths. Therefore, intensities of pieces of light in the two ring resonators are different. As a result, it is not possible for the ring resonator having the large round length to increase a light intensity to a limit at which two-photon absorption occurs. Therefore, even in the wavelength tunable laser device according to International Patent Publication No. WO 2007/029647 A1, there is a case where an output of laser light is insufficient, due to limitation in the intensity of the light in the ring resonator.

A wavelength filter according to one aspect of the present disclosure includes splitting means for splitting input light and outputting first split light and second split light, a first optical waveguide that propagates the first split light from the splitting means to a first optical coupling unit, a second optical waveguide that propagates the second split light from the splitting means to a second optical coupling unit, a first ring-shaped optical waveguide around which the first split light from the first optical coupling unit circulates, a second ring-shaped optical waveguide, around which the second split light from the second optical coupling unit circulates, having an optical path length shorter than the first ring-shaped optical waveguide, and a third optical waveguide that propagates light between a third optical coupling unit facing the first optical coupling unit in the first ring-shaped optical waveguide and a fourth optical coupling unit facing the second optical coupling unit in the second ring-shaped optical waveguide, in which a first optical path length between the splitting means and the first optical coupling unit in the first optical waveguide is shorter than a second optical path length between the splitting means and the second optical coupling unit in the second optical waveguide.

A wavelength tunable light source according to one aspect of the present disclosure includes a semiconductor optical amplifier that emits light and a wavelength filter that performs wavelength filtering on the light entered from the semiconductor optical amplifier, in which the wavelength filter includes splitting means for splitting the light input from the semiconductor optical amplifier and outputting first split light and second split light, a first optical waveguide that propagates the first split light from the splitting means to a first optical coupling unit, a second optical waveguide that propagates the second split light from the splitting means to a second optical coupling unit, a first ring-shaped optical waveguide around which the first split light from the first optical coupling unit circulates, a second ring-shaped optical waveguide, around which the second split light from the second optical coupling unit circulates, having an optical path length shorter than the first ring-shaped optical waveguide, and a third optical waveguide that propagates light between a third optical coupling unit facing the first optical coupling unit in the first ring-shaped optical waveguide and a fourth optical coupling unit facing the second optical coupling unit in the second ring-shaped optical waveguide, and a first optical path length between the splitting means and the first optical coupling unit in the first optical waveguide is shorter than a second optical path length between the splitting means and the second optical coupling unit in the second optical waveguide.

According to the present disclosure, it is possible to provide a wavelength filter and a wavelength tunable light source capable of improving an intensity of output light with a simple configuration.

### BRIEF DESCRIPTION OF THE DRAWINGS

FIG. 1 is a diagram schematically illustrating a configuration of a wavelength tunable laser device according to an example embodiment;

FIG. 2 is a diagram schematically illustrating a configuration of a wavelength filter according to the example embodiment;

FIG. 3 is a diagram schematically illustrating the configuration of the wavelength filter according to the example embodiment;

FIG. 4 is a diagram schematically illustrating the configuration of the wavelength filter according to the example embodiment; and

FIG. 5 is a diagram schematically illustrating the configuration of the wavelength filter according to the example embodiment.

### EXAMPLE EMBODIMENT

Hereinafter, example embodiments of the present invention are described with reference to the drawings. In the drawings, the same elements are denoted by the same reference signs, and redundant description will be omitted as necessary.

Hereinafter, the term “an example embodiment” means that it is applicable to any of the example embodiments described below or a combination of two or more example embodiments, and the application is not limited to a specific example embodiment.

### First Example Embodiment

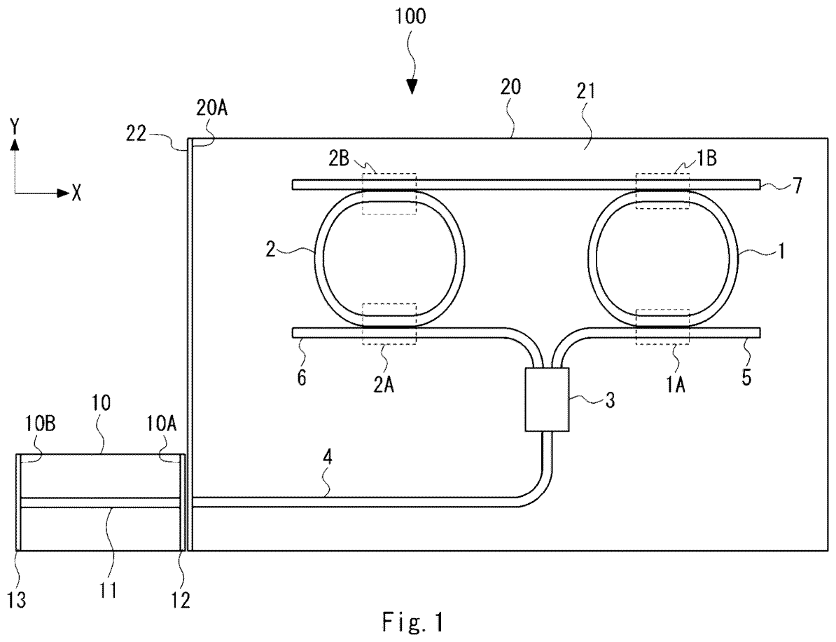

A wavelength filter according to the present example embodiment and a wavelength tunable laser device including the wavelength filter will be described. FIG. 1 is a diagram schematically illustrating a configuration of a wavelength tunable laser device according to the example embodiment. A wavelength tunable laser device 100 is configured as a wavelength tunable light source including a Semiconductor Optical Amplifier (hereinafter, SOA) 10 and a wavelength filter 20.

Hereinafter, in the drawings, for clarification of description, an XY coordinate system is introduced. The X axis is an axis, in a horizontal direction, extending rightward on paper of the drawing. The Y axis is an axis, in a vertical direction, extending upward on the paper of the drawing. A direction along the X axis is referred to as an X direction. A direction along the Y axis is referred to as a Y direction. A direction toward the right along the X direction is referred to as a +X direction, and a direction toward the left is referred to as a −X direction. An upward direction along the Y direction is referred to as a +Y direction, and a downward direction is referred to as a −Y direction.

The SOA 10 includes an optical waveguide 11 extending between an end surface 10A and an end surface 10B. In a part of the optical waveguide 11, an active region is provided. In the SOA 10, by performing current injection into the active region provided in the optical waveguide 11, light 90 is emitted from the end surface 10A to the wavelength filter 20. A non-reflective coating 12 is provided on the end surface 10A. A low-reflective coating 13 is provided on the end surface 10B.

The wavelength filter 20 includes ring-shaped optical waveguides 1 and 2, an optical multiplexer/demultiplexer 3, and optical waveguides 4 to 7, formed on a substrate 21. The wavelength filter 20 is configured, for example, as a silicon photonics element. In this case, the optical waveguide including the ring-shaped optical waveguides 1 and 2 and the optical multiplexer/demultiplexer 3, and the optical waveguides 4 to 7 are formed, for example, as optical waveguides including silicon formed on the Silicon on Insulator (SOI) substrate 21. On an end surface 20A of the wavelength filter 20 facing the SOA 10, a non-reflective coating 22 is provided.

The ring-shaped optical waveguides 1 and 2 are respectively referred to as a first and second ring-shaped optical waveguides. The optical waveguides 5 to 7 are respectively referred to as a first to third waveguides. The optical waveguide 4 is also referred to as a fourth optical waveguide. The optical multiplexer/demultiplexer 3 is also referred to as a splitter.

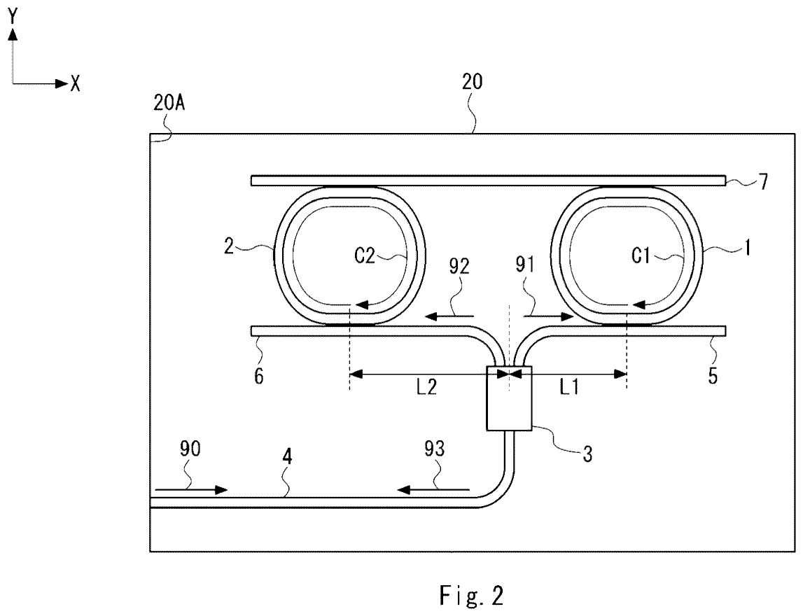

Hereinafter, the wavelength filter 20 will be described in detail. FIG. 2 is a diagram schematically illustrating a configuration of the wavelength filter according to the example embodiment. The optical waveguide 4 extends in the X direction that is an incident direction of the light 90 between the end surface 20A and the optical multiplexer/demultiplexer 3, changes its direction to the Y direction, and is connected to the optical multiplexer/demultiplexer 3. The optical multiplexer/demultiplexer 3 is a 1×2 optical multiplexer/demultiplexer. The optical multiplexer/demultiplexer 3 splits the light 90 entering from the optical waveguide 4 into split light 91 to the optical waveguide 5 and split light 92 to the optical waveguide 6. The optical multiplexer/demultiplexer 3 emits light 93 obtained by multiplexing the split light 92 entered from the optical waveguide 5 after circling the ring-shaped optical waveguides 1 and 2 and the split light 91 entered from the optical waveguide 6 after circling the ring-shaped optical waveguides 1 and 2, to the optical waveguide 4. Hereinafter, the pieces of split light 91 and 92 are also respectively referred to as first and second split light.

The optical waveguide 5 extends in the +X direction between the optical multiplexer/demultiplexer 3 and the ring-shaped optical waveguide 1. The ring-shaped optical waveguide 1 is coupled to the optical waveguide 5 at an optical coupling unit 1A. The optical waveguide 6 extends in the −X direction between the optical multiplexer/demultiplexer 3 and the ring-shaped optical waveguide 2. The ring-shaped optical waveguide 2 is coupled to the optical waveguide 6 at an optical coupling unit 2A. In this configuration, a round optical path length of the ring-shaped optical waveguide 2 is shorter than a round optical path length of the ring-shaped optical waveguide 1.

A micro heater (not illustrated) is provided near each of the ring-shaped optical waveguides 1 and 2. Heat generation is controlled by supplying a current from a drive circuit (not illustrated) to the micro heater, for example. As a result, by changing temperatures of the ring-shaped optical waveguides 1 and 2, an effective index of the ring-shaped optical waveguides 1 and 2 can be controlled by a thermooptical effect. As a result, the ring-shaped optical waveguides 1 and 2 function as ring resonators that filter only light having a desired wavelength, by a so-called vernier effect.

In the present example embodiment, an optical path length of a portion of the optical waveguide 5 between the optical multiplexer/demultiplexer 3 and the optical coupling unit 1A is designed to be shorter than an optical path length of a portion of the optical waveguide 6 between the optical multiplexer/demultiplexer 3 and the optical coupling unit 2A. That is, a length L1 of the portion of the optical waveguide 5 between the optical multiplexer/demultiplexer 3 and the optical coupling unit 1A is designed to be shorter than a length L2 of the portion of the optical waveguide 6 between the optical multiplexer/demultiplexer 3 and the optical coupling unit 2A. Hereinafter, the optical coupling units 1A and 2A are also respectively referred to as a first and second coupling units. The length L1 of the portion of the optical waveguide 5 between the optical multiplexer/demultiplexer 3 and the optical coupling unit 1A is also referred to as a first optical path length. The length L2 of the portion of the optical waveguide 6 between the optical multiplexer/demultiplexer 3 and the optical coupling unit 2A is also referred to as a second optical path length.

The ring-shaped optical waveguide 1 is coupled to the optical waveguide 7 extending in the X direction, at an optical coupling unit 1B facing the optical coupling unit 1A in the Y direction. The ring-shaped optical waveguide 2 is coupled to the optical waveguide 7 at an optical coupling unit 2B facing the optical coupling unit 2A in the Y direction. Hereinafter, the optical coupling units 1B and 2B are also respectively referred to as a third and a fourth coupling units.

The light 90 entered the optical waveguide 4 of the wavelength filter 20 from the optical waveguide 11 of the SOA 10 is split into the optical waveguides 5 and 6 by the optical multiplexer/demultiplexer 3. The split light 91 entered the ring-shaped optical waveguide 2 from the optical multiplexer/demultiplexer 3 enters the ring-shaped optical waveguide 1 from the optical coupling unit 1A. The split light 91 that has circulated the ring-shaped optical waveguide 1 enters the ring-shaped optical waveguide 2, from the optical coupling unit 1B via the optical multiplexer/demultiplexer 3 and the optical coupling unit 2B. The split light 91 that has circulated the ring-shaped optical waveguide 2 enters the optical multiplexer/demultiplexer 3, from the optical coupling unit 2A via the optical waveguide 6.

The split light 92 entered the ring-shaped optical waveguide 2 from the optical multiplexer/demultiplexer 3 enters the ring-shaped optical waveguide 2 from the optical coupling unit 2A. The split light 92 that has circulated the ring-shaped optical waveguide 2 enters the ring-shaped optical waveguide 1, from the optical coupling unit 2B via the optical multiplexer/demultiplexer 3 and the optical coupling unit 1B. The split light 92 that has circulated the ring-shaped optical waveguide 1 enters the optical multiplexer/demultiplexer 3, from the optical coupling unit 1A via the optical waveguide 5.

The split light 91 that has entered the optical multiplexer/demultiplexer 3 from the ring-shaped optical waveguide 2 via the optical waveguide 6 and the split light 92 that has entered the optical multiplexer/demultiplexer 3 from the ring-shaped optical waveguide 1 via the optical waveguide 5 are multiplexed by the optical multiplexer/demultiplexer 3. The light 93 multiplexed by the optical multiplexer/demultiplexer 3 is emitted to the optical waveguide 11 of the SOA 10, via the optical waveguide 4. As a result, light is amplified between the low-reflective coating 13 of the SOA 10 and the wavelength filter 20, and laser light having a predetermined wavelength oscillates.

As described above, in the wavelength filter 20, the length L1 of the portion of the optical waveguide 5 between the optical multiplexer/demultiplexer 3 and the optical coupling unit 1A is designed to be shorter than the length L2 of the portion of the optical waveguide 6 between the optical multiplexer/demultiplexer 3 and the optical coupling unit 2A.

Here, the round optical path length of the ring-shaped optical waveguide 1 is set to C1, and the round optical path length of the ring-shaped optical waveguide 2 is set to C2, and C1=C2+ΔC. In order to equalize an intensity of the light circling the ring-shaped optical waveguide 1 and an intensity of the light circling the ring-shaped optical waveguide 2, in the wavelength filter 20, a difference ΔL between the length L1 of the optical waveguide 5 between the optical multiplexer/demultiplexer 3 and the optical coupling unit 1A and the length L2 of the optical waveguide 6 between the optical multiplexer/demultiplexer 3 and the optical coupling unit 2A is set to be equal to ΔC.

As a result, an optical path length from the optical multiplexer/demultiplexer 3 to the optical coupling unit 1B after circling the ring-shaped optical waveguide 1 via the optical waveguide 5 becomes equal to an optical path length from the optical multiplexer/demultiplexer 3 to the optical coupling unit 2B after circling the ring-shaped optical waveguide 2 via the optical waveguide 6.

For example, in a case where ΔC=100 μm, by satisfying ΔL=100 μm, the intensity of the light circling the ring-shaped optical waveguide 1 can be equal to the intensity of the light circling the ring-shaped optical waveguide 2 having the shorter round length. As a result, while suppressing occurrence of two-photon absorption in the ring-shaped optical waveguide 1, it is possible to improve optical outputs of the wavelength filter 20 and the wavelength tunable laser device 100.

In the above, it is assumed that the optical waveguides 4 to 7 and the optical waveguide configuring the ring-shaped optical waveguides 1 and 2 have the same material and the same dimensions. It is assumed that the optical waveguide configuring the ring-shaped optical waveguides 1 and 2 be a ring-shaped optical waveguide having a bend radius that generates almost no loss in a bent portion. However, in practice, there are an influence of variations in the dimensions of the optical waveguide and a bending loss in the ring-shaped optical waveguide. On the other hand, these effects are minor as compared with an optical loss compensated by making the lengths of the optical waveguides 5 and 6 be different from each other. Therefore, even in this case, the intensities of the pieces of the light circling the ring-shaped optical waveguides 1 and 2 can be equalized, by designing the length L1 to be shorter than the length L2, in such a way as to cancel the variation of the dimensions of the optical waveguides and the influence caused by the bending loss in the ring-shaped optical waveguide.

An attenuation coefficient indicating the optical loss in the optical waveguides 4 to 7 and the optical waveguide configuring the ring-shaped optical waveguides 1 and 2 is set to α. A coupling efficiency between the optical waveguide and the ring-shaped optical waveguide is set to η. At this time, a loss difference ΔP between an optical loss P1 in the ring-shaped optical waveguide 1 and an optical loss P2 in the ring-shaped optical waveguide 2 is approximately ΔP=ΔC·α/η. Therefore, in order to compensate the loss difference ΔP by the length difference ΔL between the lengths L1 and L2, it is sufficient to satisfy ΔL =ΔP/α.

A specific example thereof will be described below. Here, it is assumed that the round optical path length C1 of the ring-shaped optical waveguide 1 be longer than the round optical path length C2 of the ring-shaped optical waveguide 2 by 50 μm (ΔC=50 μm). The attenuation coefficient α of the optical waveguide is set to 3.0 dB/cm. The coupling efficiency η between the optical waveguide and the ring-shaped optical waveguide is set to 0.1. At this time, the loss difference ΔP is ΔP=ΔC·α/η=0.15 dB. Therefore, in order to compensate the loss difference ΔP by the length difference ΔL between the lengths L1 and L2, it is sufficient to satisfy ΔL=ΔP/α=500 μm.

As described above, according to this configuration, it is possible to equalize the intensities of the pieces of the light circling the ring-shaped optical waveguides 1 and 2, by designing the length L1 of the optical waveguide 5 between the optical multiplexer/demultiplexer 3 and the optical coupling unit 1A to be shorter than the length L2 of the optical waveguide 6 between the optical multiplexer/demultiplexer 3 and the optical coupling unit 2A. As a result, while suppressing the occurrence of the two-photon absorption in the ring-shaped optical waveguide 1, it is possible to improve the optical outputs of the wavelength filter 20 and the wavelength tunable laser device 100.

### Second Example Embodiment

As described in the first example embodiment, the micro heater is provided near each of the ring-shaped optical waveguides 1 and 2, in the wavelength tunable laser device. In the present example embodiment, a configuration of the micro heaters will be described.

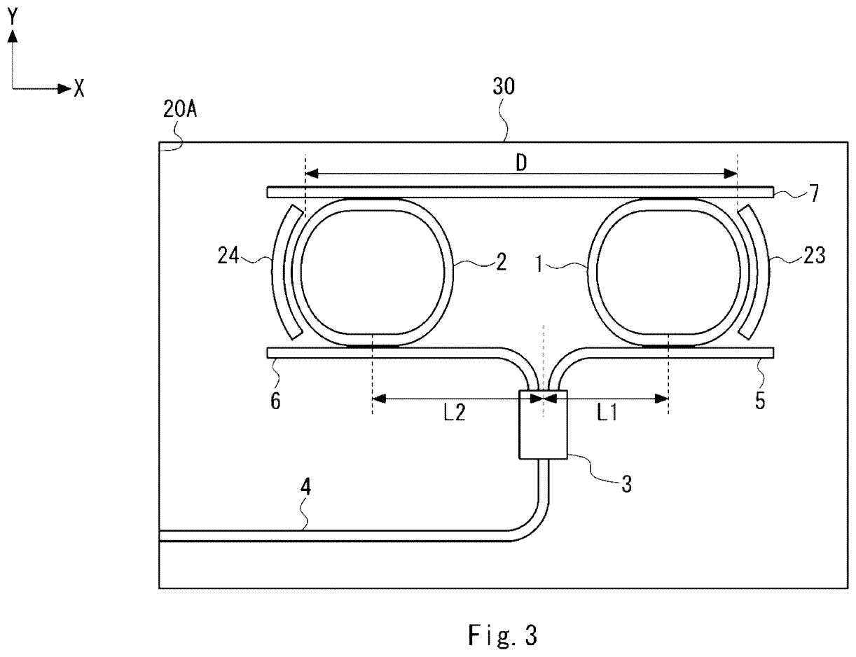

A first example of the configuration of the micro heater will be described. FIG. 3 is a diagram schematically illustrating a configuration of a wavelength filter according to the example embodiment. A wavelength filter 30 illustrated in FIG. 3 has a configuration in which micro heaters 23 and 24 are provided in a wavelength filter 20. The micro heaters 23 and 24 are also respectively referred to as a first and second heaters.

The micro heater 23 is an arc-shaped heater along the ring-shaped optical waveguide 1, provided on the outer side of the ring-shaped optical waveguide 1 in a +X direction. The micro heater 24 is an arc-shaped heater along the ring-shaped optical waveguide 2, provided on the outer side of the ring-shaped optical waveguide 2 in a −X direction.

The micro heaters 23 and 24 are arranged apart from each other by a predetermined distance, in order to prevent a mutual influence of heat generation. For example, the micro heaters 23 and 24 are preferably provided at a distance D=300 μm or more.

Therefore, in the wavelength filter 30, a length L1 between an optical multiplexer/demultiplexer 3 and an optical coupling unit 1A and a length L2 between the optical multiplexer/demultiplexer 3 and an optical coupling unit 2A are designed in such a way that the micro heaters 23 and 24 are arranged apart from each other by the predetermined distance. In this configuration, the shortest distance D between the micro heaters 23 and 24 is longer than a total of the lengths L1 and L2.

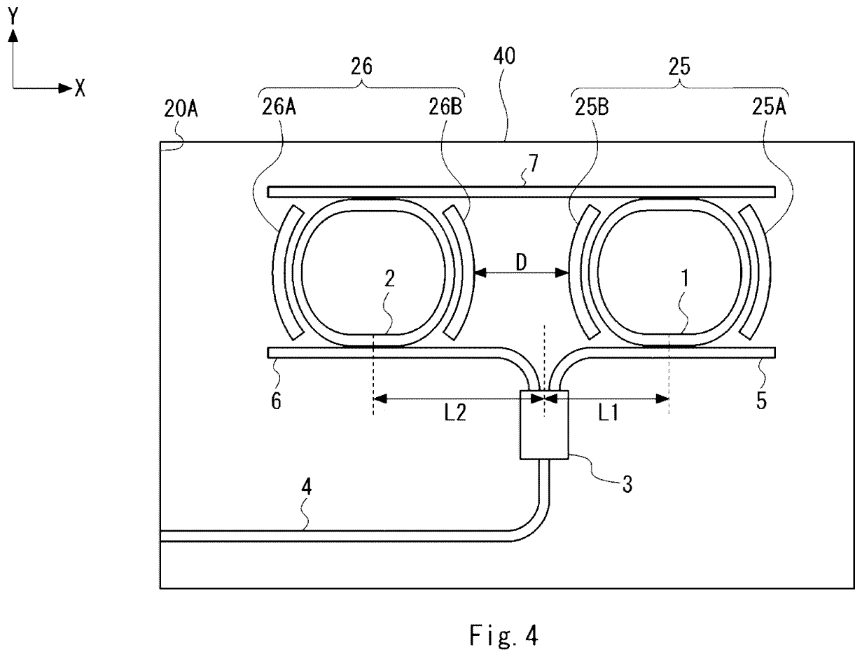

Next, a second example of the configuration of the micro heater will be described. FIG. 4 is a diagram schematically illustrating the configuration of the wavelength filter according to the example embodiment. A wavelength filter 40 illustrated in FIG. 4 has a configuration in which micro heaters 25 and 26 are provided in the wavelength filter 20. The micro heaters 25 and 26 are also respectively referred to as a first and second heaters.

The micro heater 25 includes an arc-shaped heater 25A provided along the ring-shaped optical waveguide 1 on the outer side of the ring-shaped optical waveguide 1 in the +X direction and an arc-shaped heater 25B provided along the ring-shaped optical waveguide 1 on the outer side of the ring-shaped optical waveguide 1 in the −X direction.

The micro heater 26 includes an arc-shaped heater 26A provided along the ring-shaped optical waveguide 2 on the outer side of the ring-shaped optical waveguide 2 in the −X direction and an arc-shaped heater 26B provided along the ring-shaped optical waveguide 2 on the outer side of the ring-shaped optical waveguide 2 in the +X direction.

In the wavelength filter 40, as in the wavelength filter 30, the micro heaters 25 and 26 are arranged apart from each other by the predetermined distance, in order to prevent the mutual influence of the heat generation. For example, in the wavelength filter 40, the heater 25B included in the micro heater 25 and the heater 26B included in the micro heater 26 are arranged, for example, at a distance of 300 μm or more.

Therefore, in the wavelength filter 40, the length L1 between the optical multiplexer/demultiplexer 3 and the optical coupling unit 1A and the length L2 between the optical multiplexer/demultiplexer 3 and the optical coupling unit 2A are designed in such a way that the heaters 25B and 26B are arranged apart from each other by the predetermined distance. In this configuration, the shortest distance D between the micro heaters 25 and 26 is shorter than a total of the length L1 between the optical multiplexer/demultiplexer 3 and the optical coupling unit 1A and the length L2 between the optical multiplexer/demultiplexer 3 and the optical coupling unit 2A.

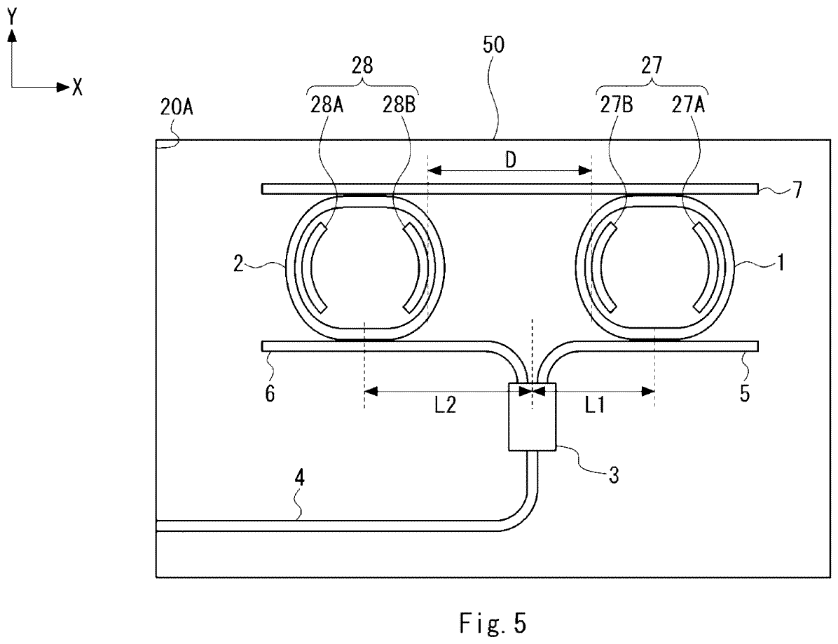

Next, a third example of the configuration of the micro heater will be described. FIG. 5 is a diagram schematically illustrating the configuration of the wavelength filter according to the example embodiment. A wavelength filter 50 illustrated in FIG. 5 has a configuration in which micro heaters 27 and 28 are provided in the wavelength filter 20. The micro heaters 27 and 28 are also respectively referred to as a first and second heaters.

The micro heater 27 includes an arc-shaped heater 27A provided along the ring-shaped optical waveguide 1 on the inner side of the ring-shaped optical waveguide 1 in the +X direction and an arc-shaped heater 27B provided along the ring-shaped optical waveguide 1 on the inner side of the ring-shaped optical waveguide 1 in the −X direction.

The micro heater 28 includes an arc-shaped heater 28A provided along the ring-shaped optical waveguide 2 on the inner side of the ring-shaped optical waveguide 2 in the −X direction and an arc-shaped heater 28B provided along the ring-shaped optical waveguide 2 on the inner side of the ring-shaped optical waveguide 2 in the +X direction.

In the wavelength filter 50, as in the wavelength filter 30, the micro heaters 27 and 28 are arranged apart from each other by the predetermined distance, in order to prevent the mutual influence of the heat generation. For example, in the wavelength filter 50, the heater 27B included in the micro heater 27 and the heater 28B included in the micro heater 28 are arranged, for example, at a distance of 300 μm or more.

Therefore, in the wavelength filter 50, the length L1 between the optical multiplexer/demultiplexer 3 and the optical coupling unit 1A and the length L2 between the optical multiplexer/demultiplexer 3 and the optical coupling unit 2A are designed in such a way that the heaters 27B and 28B are arranged apart from each other by the predetermined distance. In this configuration, the shortest distance D between the micro heaters 27 and 28 is shorter than the total of the length L1 between the optical multiplexer/demultiplexer 3 and the optical coupling unit 1A and the length L2 between the optical multiplexer/demultiplexer 3 and the optical coupling unit 2A.

As described above, by appropriately designing the lengths of the optical waveguides 5 and 6, the heaters provided near the two ring-shaped optical waveguides can be arranged apart from each other at a distance with which the heat generations of the heaters do not affect each other.

### Other Example Embodiments

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

In the second example embodiment, although an example has been described in which the micro heater is provided near each ring-shaped optical waveguide, the configuration of the micro heater is merely an example. As long as the ring-shaped optical waveguide can be controlled to have a desired temperature, the micro heater may have any configuration.

Each of the drawings is merely illustrative for describing one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing exemplary example embodiments are not necessarily mandatory, and some features or steps may be omitted. The order of the steps described in any of the drawings may be changed as appropriate.

Some or all of the above example embodiments may be described as the following Supplementary Notes, but are not limited to the following.

### (Supplementary Note 1)

A wavelength filter including:
splitting means for splitting input light and outputting first split light and second split light;
a first optical waveguide configured to propagate the first split light from the splitting means to a first optical coupling unit;
a second optical waveguide configured to propagate the second split light from the splitting means to a second optical coupling unit;
a first ring-shaped optical waveguide around which the first split light from the first optical coupling unit circulates;
a second ring-shaped optical waveguide, around which the second split light from the second optical coupling unit circulates, having an optical path length shorter than the first ring-shaped optical waveguide; and
a third optical waveguide configured to propagate light between a third optical coupling unit facing the first optical coupling unit in the first ring-shaped optical waveguide and a fourth optical coupling unit facing the second optical coupling unit in the second ring-shaped optical waveguide,
in which a first optical path length between the splitting means and the first optical coupling unit in the first optical waveguide is shorter than a second optical path length between the splitting means and the second optical coupling unit in the second optical waveguide.

### (Supplementary Note 2)

The wavelength filter according to supplementary note 1, in which an optical path length difference between the first optical path length and the second optical path length is set based on a difference between an optical loss in the first ring-shaped optical waveguide and an optical loss in the second ring-shaped optical waveguide.

### (Supplementary Note 3)

The wavelength filter according to supplementary note 2, in which
an optical path length difference between the first and the second ring-shaped optical waveguides is represented by ΔC, an attenuation coefficient of light in the first and the second optical waveguides and the first and the second ring-shaped optical waveguides is represented by α, a coupling efficiency between the first optical waveguide and the first ring-shaped optical waveguide and between the second optical waveguide and the second ring-shaped optical waveguide is represented by η, and a difference ΔP of the optical loss in the second ring-shaped optical waveguide with respect to the optical loss in the first ring-shaped optical waveguide is represented by ΔP=ΔC·α/η, and
the first and the second optical path lengths are set in such a way that a difference of the second optical path length with respect to the first optical path length becomes ΔL=ΔP/α.

### (Supplementary Note 4)

The wavelength filter according to any one of supplementary notes 1 to 3, further including:
a first heater provided for the first ring-shaped optical waveguide; and
a second heater provided apart from the first heater by a predetermined distance, for the second ring-shaped optical waveguide,
in which a value obtained by adding the first optical path length and the second optical path length is shorter than the predetermined distance.

### (Supplementary Note 5)

The wavelength filter according to supplementary note 4, in which
the first heater is arranged on an outer side of the first ring-shaped optical waveguide and at a position farther from the second heater than a center of the first ring-shaped optical waveguide, and
the second heater is arranged on an outer side of the second ring-shaped optical waveguide and at a position farther from the first heater than a center of the second ring-shaped optical waveguide.

### (Supplementary Note 6)

The wavelength filter according to any one of supplementary notes 1 to 3, further including:
a first heater provided for the first ring-shaped optical waveguide; and
a second heater provided apart from the first heater by a predetermined distance, for the second ring-shaped optical waveguide,
in which a value obtained by adding the first optical path length and the second optical path length is longer than the predetermined distance.

### (Supplementary Note 7)

The wavelength filter according to supplementary note 6, in which
the first heater is arranged on an outer side of the first ring-shaped optical waveguide and at a position closer to the second heater than a center of the first ring-shaped optical waveguide, and
the second heater is arranged on an outer side of the second ring-shaped optical waveguide and at a position closer to the first heater than a center of the second ring-shaped optical waveguide.

### (Supplementary Note 8)

The wavelength filter according to any one of supplementary notes 1 to 7, further including a fourth optical waveguide configured to guide the light incident from outside to the splitting means and guide light obtained by multiplexing light from the first optical waveguide and light from the second optical waveguide with the splitting means to the outside.

### (Supplementary Note 9)

A wavelength tunable light source including:
a semiconductor optical amplifier configured to emit light; and
a wavelength filter configured to perform wavelength filtering on the light entered from the semiconductor optical amplifier, in which
the wavelength filter includes:
splitting means for splitting the light input from the semiconductor optical amplifier and outputting first split light and second split light;
a first optical waveguide that propagates the first split light from the splitting means to a first optical coupling unit;
a second optical waveguide that propagates the second split light from the splitting means to a second optical coupling unit;
a first ring-shaped optical waveguide around which the first split light from the first optical coupling unit circulates;
a second ring-shaped optical waveguide, around which the second split light from the second optical coupling unit circulates, having an optical path length shorter than the first ring-shaped optical waveguide; and
a third optical waveguide that propagates light between a third optical coupling unit facing the first optical coupling unit in the first ring-shaped optical waveguide and a fourth optical coupling unit facing the second optical coupling unit in the second ring-shaped optical waveguide, and
a first optical path length between the splitting means and the first optical coupling unit in the first optical waveguide is shorter than a second optical path length between the splitting means and the second optical coupling unit in the second optical waveguide.

Some or all of the elements (such as configurations and functions, for example) described in Supplementary Notes 2 to 8 dependent on Supplementary Note 1 may be dependent on Supplementary Note 9 as well with dependent relationships similar to those of Supplementary Notes 2 to 8. Some or all of the elements described in any supplementary note may be applied to various types of hardware, software, recording means for recording software, systems, and methods.

1. A wavelength filter comprising:
a splitter configured to split input light and output first split light and second split light;
a first optical waveguide configured to propagate the first split light from the splitter to a first optical coupling unit;
a second optical waveguide configured to propagate the second split light from the splitter to a second optical coupling unit;
a first ring-shaped optical waveguide around which the first split light from the first optical coupling unit circulates;
a second ring-shaped optical waveguide, around which the second split light from the second optical coupling unit circulates, having an optical path length shorter than the first ring-shaped optical waveguide; and
a third optical waveguide configured to propagate light between a third optical coupling unit facing the first optical coupling unit in the first ring-shaped optical waveguide and a fourth optical coupling unit facing the second optical coupling unit in the second ring-shaped optical waveguide,
wherein a first optical path length between the splitter and the first optical coupling unit in the first optical waveguide is shorter than a second optical path length between the splitter and the second optical coupling unit in the second optical waveguide.

2. The wavelength filter according to claim 1, wherein an optical path length difference between the first optical path length and the second optical path length is set based on a difference between an optical loss in the first ring-shaped optical waveguide and an optical loss in the second ring-shaped optical waveguide.

3. The wavelength filter according to claim 2, wherein
an optical path length difference between the first and the second ring-shaped optical waveguides is represented by ΔC, an attenuation coefficient of light in the first and the second optical waveguides and the first and the second ring-shaped optical waveguides is represented by α, a coupling efficiency between the first optical waveguide and the first ring-shaped optical waveguide and between the second optical waveguide and the second ring-shaped optical waveguide is represented by η, and a difference ΔP of the optical loss in the second ring-shaped optical waveguide with respect to the optical loss in the first ring-shaped optical waveguide is represented by ΔP=ΔC·α/η, and
the first and the second optical path lengths are set in such a way that a difference of the second optical path length with respect to the first optical path length becomes ΔL=ΔP/α.

4. The wavelength filter according to claim 1, further comprising:
a first heater provided for the first ring-shaped optical waveguide; and
a second heater provided apart from the first heater by a predetermined distance, for the second ring-shaped optical waveguide,
wherein a value obtained by adding the first optical path length and the second optical path length is shorter than the predetermined distance.

5. The wavelength filter according to claim 4, wherein
the first heater is arranged on an outer side of the first ring-shaped optical waveguide and at a position farther from the second heater than a center of the first ring-shaped optical waveguide, and
the second heater is arranged on an outer side of the second ring-shaped optical waveguide and at a position farther from the first heater than a center of the second ring-shaped optical waveguide.

6. The wavelength filter according to claim 1, further comprising:
a first heater provided for the first ring-shaped optical waveguide; and
a second heater provided apart from the first heater by a predetermined distance, for the second ring-shaped optical waveguide,
wherein a value obtained by adding the first optical path length and the second optical path length is longer than the predetermined distance.

7. The wavelength filter according to claim 6, wherein
the first heater is arranged on an outer side of the first ring-shaped optical waveguide and at a position closer to the second heater than a center of the first ring-shaped optical waveguide, and
the second heater is arranged on an outer side of the second ring-shaped optical waveguide and at a position closer to the first heater than a center of the second ring-shaped optical waveguide.

8. The wavelength filter according to claim 1, further comprising a fourth optical waveguide configured to guide the light incident from outside to the splitter and guide light obtained by multiplexing light from the first optical waveguide and light from the second optical waveguide with the splitter to the outside.

9. A wavelength tunable light source comprising:
a semiconductor optical amplifier configured to emit light; and
a wavelength filter configured to perform wavelength filtering on the light entered from the semiconductor optical amplifier, wherein
the wavelength filter includes:
a splitter configured to split the light input from the semiconductor optical amplifier and output first split light and second split light;
a first optical waveguide that propagates the first split light from the splitter to a first optical coupling unit;
a second optical waveguide that propagates the second split light from the splitter to a second optical coupling unit;
a first ring-shaped optical waveguide around which the first split light from the first optical coupling unit circulates;
a second ring-shaped optical waveguide, around which the second split light from the second optical coupling unit circulates, having an optical path length shorter than the first ring-shaped optical waveguide; and
a third optical waveguide that propagates light between a third optical coupling unit facing the first optical coupling unit in the first ring-shaped optical waveguide and a fourth optical coupling unit facing the second optical coupling unit in the second ring-shaped optical waveguide, and
a first optical path length between the splitter and the first optical coupling unit in the first optical waveguide is shorter than a second optical path length between the splitter and the second optical coupling unit in the second optical waveguide.
